(19) United States
(12) Patent Application Publication
(10) Pub. No.: US 2006/0175360 A1
(43) Pub. Date: Aug. 10, 2006

(54) Container with a surface storage cavity

(75) Inventor: David Charles Greenall, Arroyo Grande, CA (US)

Correspondence Address: DLA PIPER RUDNICK GRAY CARY US, LLP, 2000 UNIVERSITY AVENUE, E. PALO ALTO, CA, 94303-2248, US

(73) Assignee: David Charles Greenall

(21) Appl. No.: 11/051,067

(22) Filed: Feb. 4, 2005

(51) Int. Cl. B67D 3/00

(52) U.S. Cl. 222/530

(57) ABSTRACT

The invention is a container with a storage cavity formed on its outer surface. Many products today come in a container that requires a peripheral part for proper application. Usually, application of these products is difficult without the peripheral part or the tool. Thus, the user is burdened with having to remember where the peripheral part is or remembering to carry the peripheral part along with the product. By integrating a storage cavity into the container, the invention relieves the user of this burden. An exemplary application is in the case of tire sealants. A tire sealant comes in a container and is usually used with a filler tube that is used to transfer the sealant to the tire. With the invention, the filler tube may be securely stored in the storage cavity formed on the sealant container.

### FIELD OF INVENTION

This invention pertains generally to a container and particularly to a sealant container.

### BACKGROUND

Various puncture sealing preparations are available on the market. These sealants usually include a rubber composition, and are sold in a pressure-tight container that holds not only the rubber composition but also liquefied gas (e.g., a propane/butane mixture). To use the sealants, the outlet valves of these containers are connected to one end of a tube, the other end of which can be connected to a tire valve. The sealant material is transferred from the container to the inside of the tire through the tube. The gas, which is de-pressurized when it comes out of the container, inflates the tire. After the sealant is transferred, the tire is driven on or rolled to distribute the sealant on the inner wall of the tire.

Alternatively, sealants are sold in a compressible container that can be connected to the tire valve, for example with a filler tube. For this type of sealant container, the tire core sometimes has to be removed before the tube can be connected to the tire valve. Once the connection is made, the sealant is sprayed into the tire by squeezing the container. Then, the valve core is put back on and the tire is pumped up to the desired pressure.

Regardless of which sealant one buys, its usefulness depends on the availability of peripheral parts such as the filler tube and sometimes the valve core remover. Even if one has a container of sealant, the sealant cannot be applied without the filler tube and the valve core remover. Given that the tube and the valve core remover are relatively small parts that are easily lost or forgotten, the usefulness of the sealant depending on these peripheral parts causes an inconvenience to many users.

A method of keeping the peripheral parts and the sealant container as one integrated unit is desired.

### SUMMARY

In one aspect, the invention is a bottle. The bottle includes a container having an outer surface, a storage cavity formed on the outer surface, and a securing mechanism for holding an object in the storage cavity.

In another aspect, the invention is a kit. The kit includes a container having a storage cavity formed on its outer surface. The kit also includes tube that is designed to securely fit in the storage cavity when not in use. When in use, the tube is connected to an opening in the container for transferring substances into or out of the container.

In yet another aspect, the invention is a tire sealant product using the above bottle. More specifically, the product includes a container holding the sealant, an opening in the container, a storage cavity formed on an outer surface of the container, and a tube that is shaped to connect with the opening. The tube is designed to fit in the storage cavity when not being used to transfer the sealant out of the container.

### BRIEF DESCRIPTION OF THE DRAWING(S)

FIG. 1 is a plan view of an of the bottle in accordance with the invention.

FIG. 2, FIG. 3, and FIG. 4 are plan views of alternative embodiments of the bottle.

FIG. 5 is a perspective view of a filler tube that may be placed in the cavity.

FIG. 6 is a plan view of the bottle with the filler tube of FIG. 5.

FIG. 7 is a plan view of a bottle top that may be used with the bottle.

FIG. 8 is a plan view of the bottle top of FIG. 7 combined with the filler tube of FIG. 5.

FIG. 9A is a plan view of a cap that can be used to close the opening.

FIG. 9B is a plan view of the cap of FIG. 9A combined with the bottle top of FIG. 7.

### DETAILED DESCRIPTION OF THE PREFERRED EMBODIMENT(S)

Embodiments of the invention are described herein in the context of tire sealant. However, it is to be understood that the embodiments provided herein are just preferred embodiments, and the scope of the invention is not limited to the applications or the embodiments disclosed herein. For example, the invention may be adapted for other types of applications that include a container of liquid and/or gas and some peripheral parts.

As used herein, a “bottle” is any form of a container with an opening, including but not limited to a can, a squeezable bottle, a carton, or a bag. The bottle may be made of a metal, a polymeric material, plastic, a paper product, glass, ceramic, or a combination thereof. An “object” is any physical object and is not limited to a composition or shape. A “tube” is an elongated object having an opening extending through it.

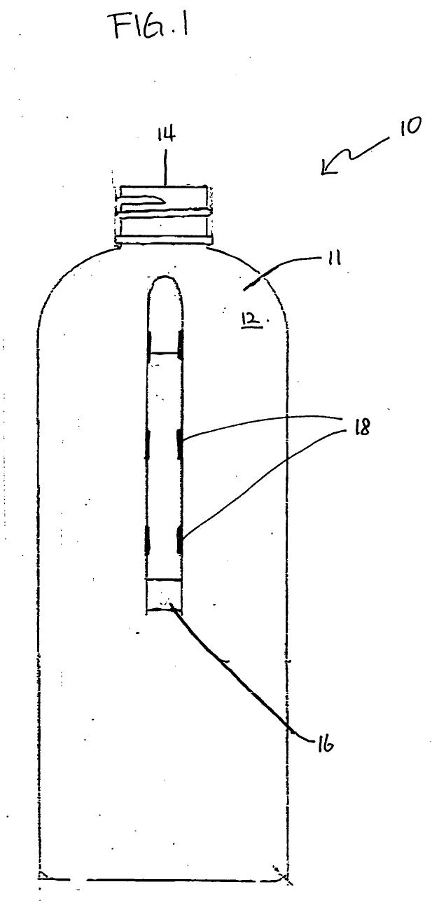

FIG. 1 is a first embodiment of a bottle 10 in accordance with the invention. The bottle 10 includes a container 11 with an outer surface 12, an opening 14, and a cavity 16 formed on the outer surface 12. A securing mechanism 18 is located near the cavity 16 for keeping an object partially or entirely inside the cavity 16. The opening 14 may be any type of opening suitable for filling and emptying the container 10, including but not limited to a plain opening with treads around it, a bottle top, and/or a nozzle. The cavity 16 is shaped and sized to accommodate the object that will be placed in it. In the embodiment shown, the mechanism 18 is a set of plastic tabs positioned near the inner wall of the cavity 16. The plastic tabs may be about ⅛″ to about 1/16″ in thickness and made of high-density polyethylene (HDPE) or any other material normally used to manufacture plastic bottles.

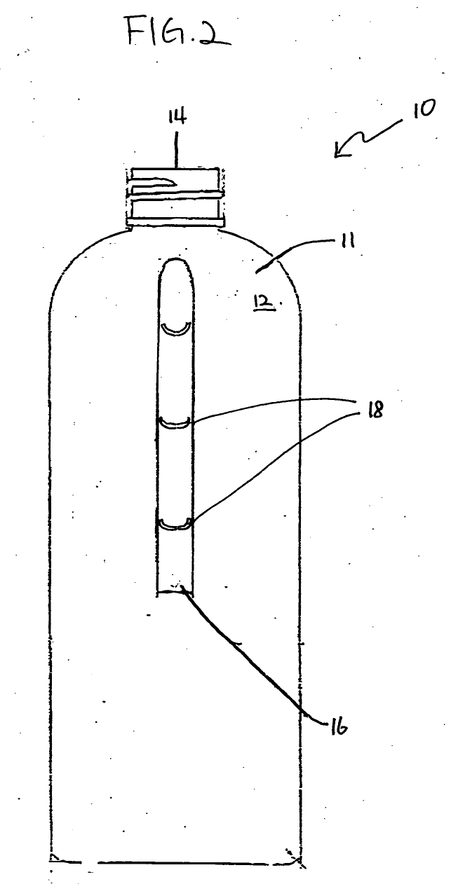

FIG. 2, FIG. 3, and FIG. 4 are plan views of some alternative embodiments of the bottle 10. In FIG. 2, the securing mechanism 18 is a set of structures the object can be “clicked” into. In FIG. 3, the securing mechanism 18 is an adhesive layer onto which the object can be attached. Any well-known adhesive material may be used for the embodiment of FIG. 3. The tack level of the adhesive material is controlled so that the object can be detached without damage to the cavity 16 or to the object. In FIG. 4, the securing mechanism 18 is a door that encloses the cavity 16 when shut. Although FIG. 4 shows a door with hinges 19, the embodiment of FIG. 4 is not so limited. Any of these securing mechanisms 18 can be used in combination, as desired, without deviating from the scope of the invention. Other mechanical securing mechanisms, such as a belt, band, clip, or tape tied around the container 10, are also contemplated.

Although FIGS. 1, 2, 3, and 4 show the cavity 16 as being a groove or an indentation on the outer surface 12, embodiments where walls of the cavity 16 protrude from the outer surface 12 are also contemplated.

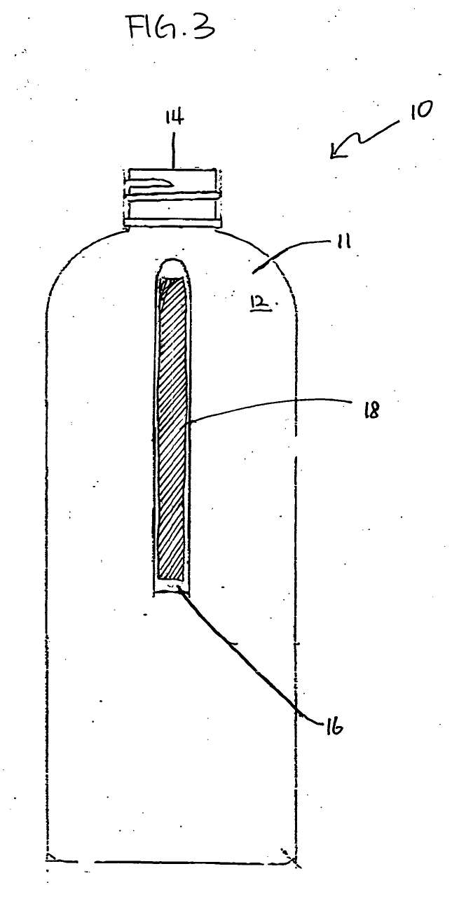

FIG. 5 is a perspective view of a filler tube 20 that may be placed in the cavity 16. The dimensions of the filler tube 20 is selected to fit with the opening 14 to transfer the sealant out of the container 10 substantially without dripping or leaking. Usually, one end of the filler tube 20 fits around the opening 40 and the other end of the filler tube fits into the tire valve core (not shown). The shape and the dimensions of the filler tube 20 are selected to fit in the cavity 16 and be secured by the securing mechanism 18. The filler tube 20 is usually made of a clear flexible polymeric material, and is typically about 4 to about 6 inches long.

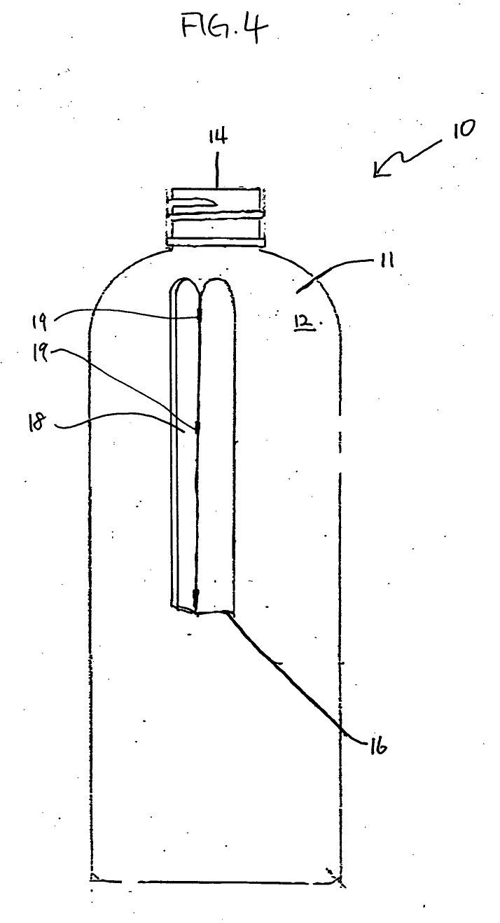

FIG. 6 is a plan view of the bottle 10 with the filler tube 20 positioned in the cavity 16. Any securing mechanism 18 (not shown) may be used to secure the filler tube 20 so that it does not fall out when the bottle 10 is moved.

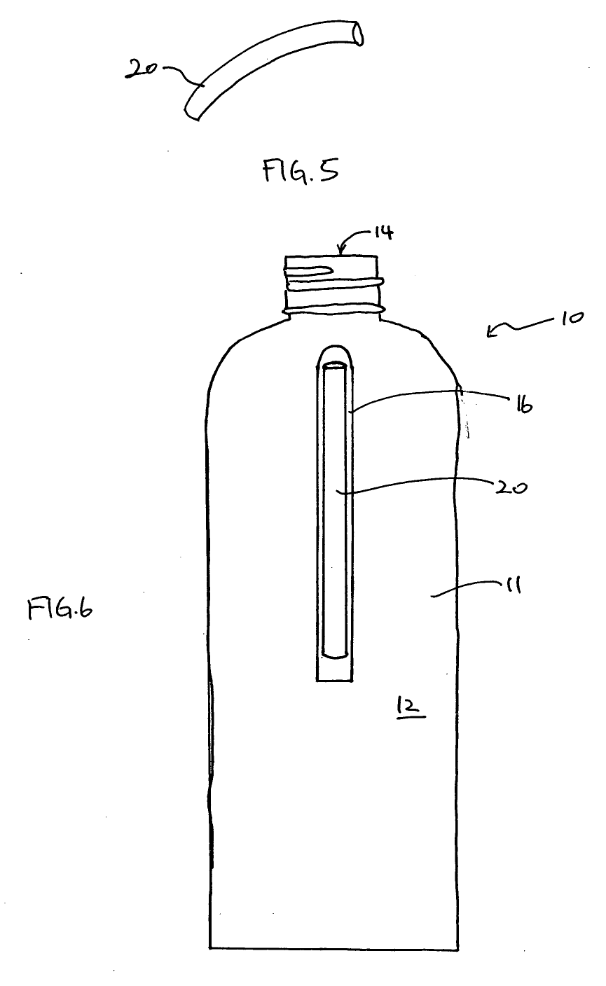

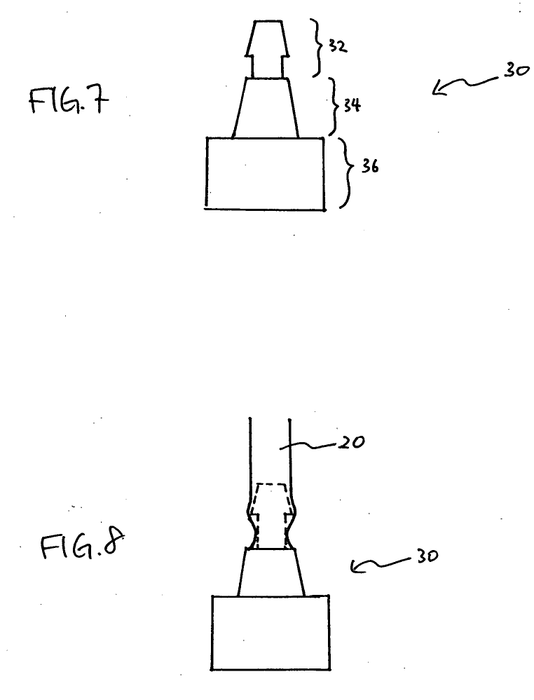

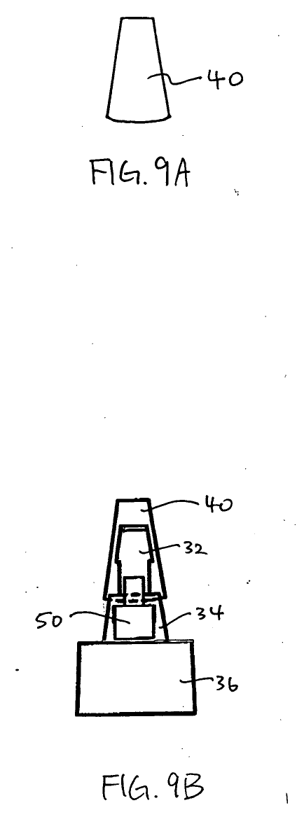

FIG. 7 is a plan view of a bottle top 30 that may be connected to the bottle 10, near the opening 14. In the embodiment that is shown, the bottle top 30 has a first section 32, a second section 34, and a third section 36. The first section 32 is designed to fit with a filler tube 20, as shown below in FIG. 8. The second section 34 may be hollow, designed to hold a peripheral part, as shown below in FIG. 9B. The third section 36 is for securely connecting the bottle top 30 to the bottle 10. For example, where the bottle 10 has threads near the opening 14, the inner wall of the third section 36 may be designed to screw onto the opening 14.

FIG. 8 is a plan view of the bottle top 30 combined with the filler tube 20. As shown, the filler tube 20 fits around the first section 32 of the bottle top 30 to receive the sealant that comes out of the opening 14. Although not shown, the other end of the filler tube 20 is connected to the tire valve core. As sealant comes out of the bottle top 30, the filler tube 20 fills up and the sealant gets pushed into the tire valve.

FIG. 9A is a plan view of a cap 40 that can be used to close the opening 14 when the bottle top 30 is used. The cap 40 may be made of the same material as the container 10. The outline of the cap 40 is not limited to any shape as long as the inner walls of the cap 40 are designed to snugly fit around the bottle top 30 and prevent the content of the container 10 from spilling.

FIG. 9B is a plan view of a cap 40 combined with the bottle top 30. FIG. 9B also shows a valve core remover 50 positioned inside the second section 34. Sometimes, in sealing a tire, the valve core remover 50 is needed to remove the tire valve core prior to injecting or spraying the sealant into the tire. By designing the second section 34 to function as a valve core storage compartment, a user of the sealant does not have to worry about carrying the valve core remover 50 separately to use the sealant. Preferably, there is a dividing wall between the second section 34 and the third section 36 to prevent the valve core remover 50 from falling into the container 10. The dividing wall may be a solid plane or a surface with cutouts therein. The valve core remover 50 may be taken out of the second section 34 by separating the second section 34 from the first section 32 and/or the third section 36.

Although preferred embodiments of the present invention have been described in detail hereinabove, it should be clearly understood that many variations and/or modifications of the basic inventive concepts herein taught which may appear to those skilled in the present art will still fall within the spirit and scope of the present invention.

What is claimed is:

1. A bottle, the bottle comprising:
a container having an outer surface;
a storage cavity formed on the outer surface; and
a securing mechanism for holding an object in the storage cavity.

2. The bottle of claim 1 further comprising an opening for filling and emptying the container.

3. The bottle of claim 1, wherein the securing mechanism comprises a set of tabs.

4. The bottle of claim 3, wherein the tabs are about ⅛″ to about 1/16″ thick.

5. The bottle of claim 3, wherein the tabs comprise high density polyethylene (HDPE).

6. The bottle of claim 1 further comprising a door for the storage cavity.

7. The bottle of claim 1, wherein the outer surface comprises a sidewall and a base, wherein the storage cavity is formed on the sidewall.

8. The bottle of claim 1, wherein the storage cavity has an elongated shape.

9. The bottle of claim 1, wherein the container is made of one of a polymer, metal, plastic, paper product, ceramic, and glass.

10. The bottle of claim 1, wherein the storage cavity is a groove formed on the outer surface of the container.

11. The bottle of claim 1, wherein the securing mechanism comprises an adhesive layer located inside the storage cavity.

12. A kit comprising:
a container having an opening and an outer surface, wherein the outer surface has a storage cavity formed thereon; and
a tube that is shaped to connect to the opening and designed to securely fit in the storage cavity when not in use.

13. The kit of claim 12 further comprising a latex rubber composition for filling the container.

14. The kit of claim 12, wherein the container holds a latex rubber composition.

15. The kit of claim 12 further comprising a bottle top detachably connected to the opening of the container.

16. The kit of claim 15 further comprising a tool for opening a tire valve, wherein the tool is located in the bottle top.

17. The kit of claim 12 further comprising a cap for closing the opening.

18. A tire sealant product comprising:
a container holding the sealant;
an opening in the container;
a storage cavity formed on an outer surface of the container;
a tube that is shaped to connect with the opening when attached to the opening and to fit in the storage cavity when placed in the indented portion.

19. The product of claim 18, wherein the storage cavity is a groove formed on the outer surface of the container.

20. The product of claim 18 further comprising a securing mechanism in the storage cavity for holding the tube.

21. The product of claim 18 further comprising:
a bottle top designed to attach to the opening for directing the sealant coming out of the container, wherein the bottle top has a storage space.

22. The product of claim 21 further comprising a tool located in the storage space.

23. A method of storing an object, the method comprising:
placing the object in a storage cavity on an outer surface of a container; and
securing the object in the storage cavity by using a securing mechanism, wherein the securing mechanism.

24. The method of claim 23, wherein the securing mechanism comprises a mechanical means selected from a group consisting of tabs, belt, band, clip, and tape.

25. The method of claim 23, wherein the securing mechanism comprises an adhesive layer located inside the storage cavity.
